(19) United States
(12) Patent Application Publication
(10) Pub. No.: US 2026/0336745 A1
(43) Pub. Date: Oct. 29, 2026

(54) FORK ASSEMBLY WITH INTEGRATED OIL DRAIN AND REFILL SYSTEM

(71) Applicant: Fox Factory, Inc., Duluth, GA (US)

(72) Inventors: Joshua Coaplen, Asheville, NC (US); Daniel McCormick, Santa Cruz, CA (US)

(21) Appl. No.: 19/192,733

(22) Filed: Apr. 29, 2025

(51) Int. Cl. B62K 25/08; F16F 9/43

(52) U.S. Cl. CPC B62K 25/08; F16F 9/435

(57) ABSTRACT

The present disclosure provides a fork assembly configured to couple to a frame of a bicycle or like vehicle and support a front wheel. The fork assembly includes a fork upper and a fork lower having fork lower tubes telescopically coupled to those of the fork upper, and bath oil contained within the fork lower tubes. A drain port is positioned at a lower end of the fork lower tube that enables drainage of the bath oil. A drain plug is removably coupled to the drain port. A refill port is positioned at an upper end of the fork lower tube, which can include a bleeder port. A bleeder valve can removably couple to the bleeder port. The refill port is configured to allow refilling of the bath oil when the bleeder valve is removed.

### TECHNICAL FIELD

The present disclosure generally relates to suspension systems for vehicles and, in particular, to a fork assembly for a bicycle or motorcycle having an integrated oil drain and refill system.

### BACKGROUND

Suspension systems for vehicles, particularly bicycles and motorcycles, often utilize fork assemblies to absorb shocks and vibrations during operation. These fork assemblies typically contain bath oil to lubricate telescoping components and maintain optimal performance. However, over time, the bath oil can become contaminated or degraded, necessitating periodic replacement to prevent wear and maintain proper function of the suspension system.

Traditionally, changing the bath oil in a fork assembly has been a complex and time-consuming process, often requiring specialized tools, removal of the fork from the vehicle, or disassembly of the fork components. This complexity can discourage regular maintenance, potentially leading to reduced performance and increased wear on the suspension components. As such, there is a need for improved systems and methods to simplify the process of changing bath oil in fork assemblies while maintaining the integrity and functionality of the suspension system.

### BRIEF SUMMARY

Various aspects are disclosed for a fork assembly for a bicycle or motorcycle having an integrated oil drain and refill system. According to an aspect of the present disclosure, a vehicle is provided. The vehicle includes a frame, a front wheel, a rear wheel, and a fork assembly coupled to the frame and supporting the front wheel. The fork assembly comprises a fork upper tube, a fork lower tube telescopically coupled to the fork upper tube, the fork lower tube being configured to contain bath oil, a drain port positioned at a lower end of the fork lower tube, the drain port configured to allow drainage of the bath oil, and a refill port positioned at an upper end of the fork lower tube.

The drain port may be positioned at a lowest portion of the fork lower tube when the fork assembly is installed on a vehicle and the vehicle is in its operating position. The vehicle may be a motorcycle or a bicycle, or other vehicle.

According to another aspect of the present disclosure, a fork assembly is provided. The fork assembly includes a fork lower tube configured to telescopically couple to a fork upper tube, the fork lower tube comprising an inner reservoir, a bath oil drainage channel, a drain port positioned at a lower end of the fork lower tube, the drain port being fluidly coupled to the bath oil drainage channel and configured to permit drainage of bath oil from the inner reservoir to an exterior of the fork lower tube, and a refill port positioned at an upper end of the fork lower tube, wherein the refill port is configured to allow refilling of the bath oil.

The bath oil drainage channel may be oriented in a direction extending substantially parallel to a longitudinal axis of the fork lower tube. The bath oil drainage channel may be oriented in a direction transverse to the longitudinal axis of the fork lower tube. The fork assembly may further comprise a bottom out bumper. The bath oil drainage channel may extend below a bottom surface of the inner reservoir.

The bath oil drainage channel may be at least partially formed in a side wall of the lower fork tube. The bath oil drainage channel may be at least partially formed in a bottom wall of the lower fork tube. The drain port may be positioned at a lowest portion of the fork lower tube.

The fork assembly may further comprise a drain sealing device coupled to the drain port and configured to seal and unseal the drain port. The refill port may be a bleeder port, and the fork assembly may further comprise a bleeder valve coupled to the bleeder port. The bleeder port may be configured to equalize pressure between an interior of the fork lower tube and ambient pressure when the port is open. The drain port may be located at a rear surface of the fork lower tube. The refill port may be positioned above a maximum fill level of the bath oil. The bottom-out bumper may comprise at least one channel configured to facilitate drainage of the bath oil through the drain port. The bath oil drainage channel may be configured to drain the bath oil from an outer region and from an inner region surrounding the bottom out bumper.

According to another aspect of the present disclosure, a front suspension is provided. The front suspension includes an upper tube, a lower tube telescopically coupled to the upper tube, the lower tube being configured to contain bath oil, a drain port positioned at a lower end of the lower tube, the drain port configured to allow drainage of the bath oil, a drain sealing device coupled to the drain port, a refill port positioned at an upper end of the fork lower tube, and a refill port sealing device coupled to the refill port, wherein the refill port is configured to allow refilling of the bath oil when the refill port is open. The drain port may be positioned at a lowest portion of the fork lower tube.

This summary is provided to introduce a selection of concepts in a simplified form that are further described below in the detailed description, and is not intended to identify key features or essential features of the claimed subject matter, nor is it intended to be used as an aid in determining the scope of the claimed subject matter. The foregoing general description of the illustrative embodiments and the following detailed description thereof are merely exemplary aspects of the teachings of this disclosure and are not restrictive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1 and 2 illustrate various perspective views of a fork lower of a fork assembly having a drain port in a horizontal orientation according to various embodiments of the present disclosure.

FIGS. 3-5 show various perspective views of the fork lower having a drain port in a vertical orientation according to various embodiments of the present disclosure.

FIG. 6 illustrates a partial cross-section and partial perspective view of a fork lower having a drain port in a horizontal orientation according to various embodiments of the present disclosure.

FIG. 7 illustrates a cross-section view of a drain port and drain plug according to various embodiments of the present disclosure.

FIG. 8 illustrates a partial cross-sectional and a partial perspective view of a fork lower having a drain port in a vertical orientation according to various embodiments of the present disclosure.

FIG. 9 illustrates a bottom perspective view of a portion of the bicycle fork assembly according to various embodiments of the present disclosure.

FIG. 10 illustrates a perspective view of a bicycle fork assembly according to various embodiments of the present disclosure.

### DETAILED DESCRIPTION

The present disclosure relates to a fork assembly having an integrated oil drain and bleeder system according to various embodiments. Suspension systems for vehicles, particularly bicycles and motorcycles, often utilize fork assemblies to absorb shocks and vibrations during operation. These fork assemblies typically contain bath oil within the fork lowers to lubricate telescoping components and maintain optimal performance. For instance, the bath oil can lubricate pistons, shafts, and other translating internal components of the fork assembly. The bath oil is a volume of free-flowing oil that splashes or otherwise moves around inside the fork assembly and a fork lower thereof, often coating bushings between the fork lower and the fork upper to keep the tubes and inner components thereof lubricated.

At the top of the fork lower, wiper seals are often provided to remove water, contaminants, or dirt as the lower translates on the fork upper. Thus, the wiper seals help to prevent debris from entering the bath oil contained within the fork lower. However, over time, some contaminants make their way past the wiper seals, causing the bath oil to become dirty and degraded. Generally, it is recommended to replace the bath oil after 125 hours of use of a fork assembly.

As such, periodic replacement of the bath oil is a necessary service procedure to maintain performance and longevity of the fork assembly. Traditionally, bath oil replacement has been complex and time-consuming, often requiring specialized tools and expertise. For example, some methods require loosening foot-nuts that attach an air spring shaft and a damper shaft to the fork lower, using special tools to interface with the shafts, and then forcibly separating the components. This process can be challenging, especially for home mechanics, as it requires careful disassembly and reassembly of the fork components and requires the use of special tools.

Once the fork lower is separated from a fork upper, the old bath oil is typically poured out into a bucket or other receptacle. The fork assembly is then inverted, and new oil is poured back through holes before being plugged by base studs. The specified volume of oil must be carefully measured and added. The fork assembly is assembled while inverted. Finally, the foot-nuts are retightened and the fork assembly reinstalled on a vehicle.

This arduous procedure discourages regular maintenance, leading to reduced performance and increased wear on the suspension components. As such, it can be beneficial to simplify the process of changing bath oil in fork assemblies while maintaining integrity and functionality of a fork assembly and suspension system.

Accordingly, various embodiments are described herein for a fork assembly having an integrated oil drain and refill system. The fork assembly can include a fork lower, where the fork lower includes fork lower tubes telescopically coupled to fork upper tubes, with bath oil contained within the fork lower tubes. A drain port can be positioned at a lower end of one or both of the fork lower tubes to allow drainage of the bath oil, while a refill port fluidly coupled to an inner reservoir of the fork lower can be positioned at an upper end of one or both of the fork lower tubes to facilitate refilling and draining of the bath oil.

In some embodiments, the drain port can be positioned at a lowest portion of the fork lower tube. In some embodiments, the lowest portion of the fork lower tube is defined when the fork is installed on a vehicle and the vehicle is in its operating position. In some embodiments, the drain port is oriented generally in a direction transverse to the longitudinal axis of the fork lower tube. In some embodiments, the drain port is oriented generally parallel to the longitudinal axis of the fork lower tube.

In some embodiments, the drain port can be located at a lower end of the fork lower tube. In some embodiments, the drain port can be located at a rear surface of the fork lower tube, or at a side surface of the fork lower tube, or at a front surface of the fork lower tube or in any intermediate position. In some embodiments, the drain port can include a projection extending from an outer surface of the fork lower tube generally in a direction transverse to the longitudinal axis of the fork lower tube. In some embodiments, the drain port can include a projection extending from an outer surface of the fork lower tube in a direction parallel the longitudinal axis of the fork lower tube. In some embodiments, the drain port can be coupled with a drain sealing device such as a drain plug, a drain cover, a valve, or the like. In some embodiments, the drain plug can be a removable drain plug, or otherwise adjustable drain sealing device that can seal and unseal the drain port. The drain plug can include a tapered interface configured to form a seal with the drain port.

In some embodiments, the refill port can include a refill port sealing device. In some implementations, the refill port sealing device may include a valve, a plug, or a cover, or the like, configured to seal and unseal the refill port. In some implementations, the refill port can include a bleeder port having a bleeder valve and/or a cover coupled to the bleeder port that, when manipulated, equalizes pressure between the interior of the fork lower tube and ambient pressure. The bleeder valve and/or cover can be removed or otherwise adjusted or manipulated such that bath oil can be poured into the bleeder port. This configuration allows for efficient draining and refilling of bath oil without requiring disassembly of the fork assembly and without having to remove or invert the fork assembly.

The fork assembly can also include a bottom-out bumper positioned within the fork lower tube. In some embodiments, the drain port can include a drain channel that is in a generally horizontal orientation. In some embodiments, the drain channel is oriented generally in a direction transverse to the longitudinal axis of the fork lower tube. In some embodiments, the drain channel is configured to allow drainage of the bath oil via an aperture at least partially located on a bottom surface of an inner reservoir of the fork lower tube. In some embodiments, the aperture can be at least partially positioned within an inner diameter of the bottom-out bumper. In some embodiments, the aperture can be at least partially formed in a sidewall of the inner reservoir. In some embodiments, the drain channel is configured to allow drainage of the bath oil from an outer region and from an inner region surrounding the bottom-out bumper. The bottom-out bumper can include a channel to facilitate drainage of the bath oil through the drain port, which can enable more complete drainage of the bath oil during maintenance procedures, improving the overall performance and longevity of the suspension system.

In other embodiments, the drain port includes a bath oil drainage channel that is oriented generally vertically. In some embodiments, the drain port includes a bath oil drainage channel that is oriented generally parallel to a longitudinal axis of the fork lower tube. In some embodiments, the bath oil drainage channel can extend below a bottom surface of the inner reservoir of the fork tube. In some embodiments, the bath oil drainage channel can extend below the bottom surface of the inner reservoir and/or above the bottom-out bumper. In some embodiments, the drain channel is configured to allow drainage of the bath oil from an outer region and from an inner region surrounding the bottom-out bumper. In some embodiments, the drain channel is configured to allow drainage of the bath oil via an aperture at least partially formed in the bottom surface of the inner reservoir of the fork lower tube. In some embodiments, the aperture can be at least partially formed in a sidewall of the inner reservoir. The bottom-out bumper can include a channel to facilitate drainage of the bath oil through the drain port, which can enable more complete drainage of the bath oil during maintenance procedures, improving the overall performance and longevity of the suspension system.

The bath oil of the fork assembly described herein can be replaced without having to remove and invert the fork assembly. Instead, it can be replaced while the fork assembly is assembled to the bicycle or other vehicle.

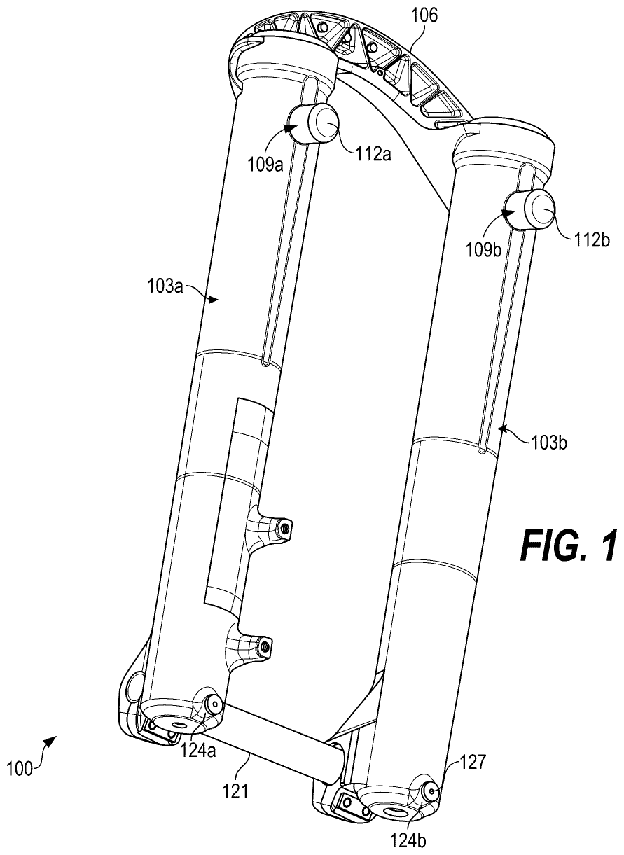

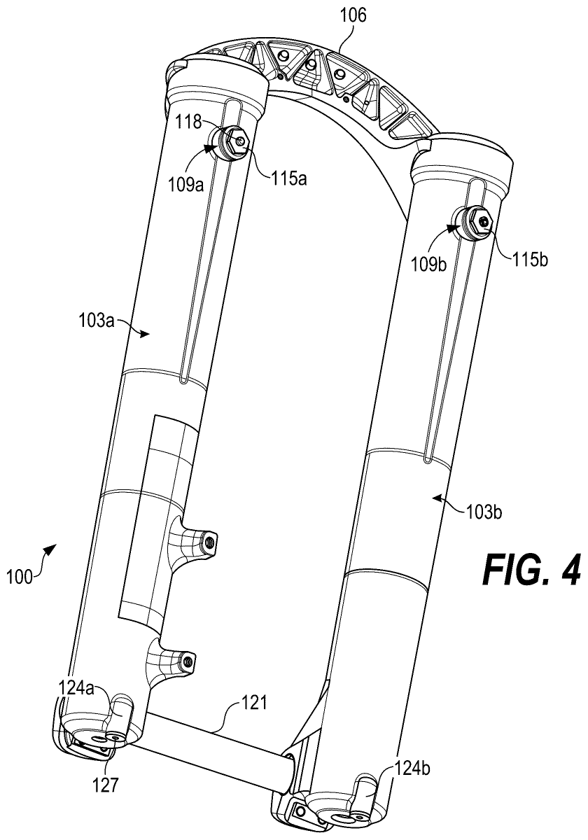

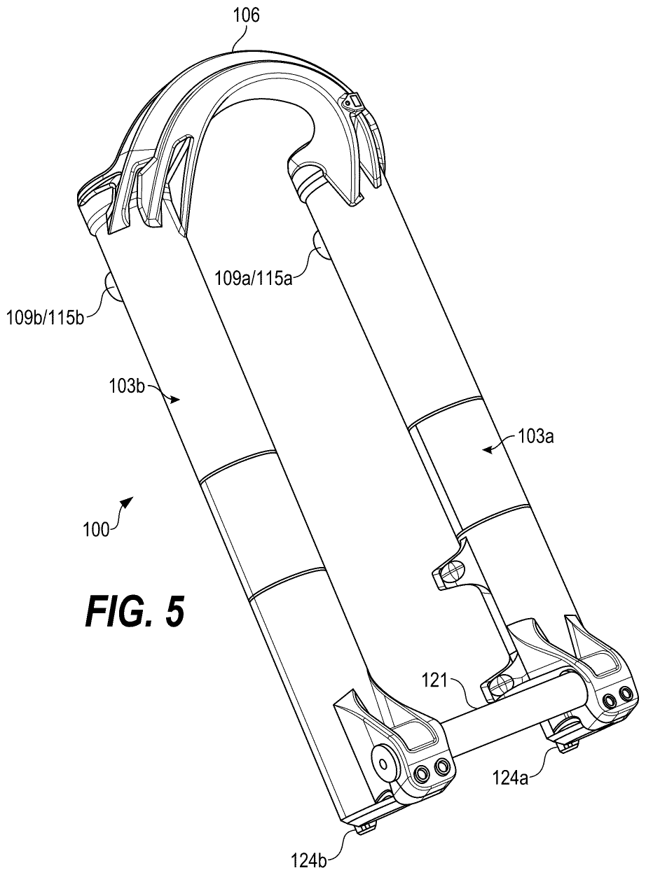

Turning now to the drawings, FIGS. 1-5 illustrate various perspective views of a fork lower 100 of a fork assembly according to various embodiments of the present disclosure. Specifically, FIGS. 1-4 are perspective rear views of various embodiments of the fork lower 100, and FIG. 5 is a front view of the fork lower 100 according to various embodiments.

Referring collectively to FIGS. 1-5, the fork lower 100 can be part of a shock absorber or like suspension for a vehicle. In some embodiments, the vehicle includes a bicycle, a motorcycle, a dirt bike, an electric bike (e-bike), a snow bike or like motorized or non-motorized vehicle. Moreover, in some embodiments, the bicycle includes a mountain bike, a street bike, a racing bike, and so on.

A shock absorber can include, for example, a front fork incorporating the fork lower 100 shown in the figures as well as a fork upper which is omitted for explanatory purposes. The fork lower 100 can include a first fork lower tube 103a and a second fork lower tube 103b (collectively “fork lower tubes 103” or “tubes 103”), positioned substantially parallel with respect to one another. The first fork lower tube 103a and the second fork lower tube 103b can be coupled to one another via an arch 106 in some implementations. Respective tubes of a fork upper (not shown) can be positioned in upper ends of the fork lower tubes 103a, 103b of the fork lower 100. Thus, a telescoping connection between the fork upper and the fork lower 100 can be formed.

The fork lower tubes 103 can have a generally circular cross-section, which can provide structural integrity and telescoping movement in connection with the fork upper. The circular profile of the fork lower tubes 103 can facilitate distribution of stresses and loads during compression and rebound of the suspension. The diameter of the fork lower tubes 103 can be selected based on factors such as the intended use of the vehicle, desired stiffness, and overall weight considerations. In some cases, the fork lower tubes 103 can incorporate slight tapering or variable wall thickness along their length to optimize performance characteristics. The circular geometry can also allow for efficient sealing at the interface between the fork lower tubes 103 and the corresponding upper tubes, helping to prevent contamination of the bath oil within. In some embodiments, the fork lower tubes 103 may have a generally non-circular cross-section.

According to various embodiments, each of the first fork lower tube 103a and the second fork lower tube 103b can include one or more refill ports for refilling bath oil in the fork lower tubes 103. In some embodiments, the refill ports include a first bleeder port 109a and a second bleeder port 109b (collectively “bleeder ports 109”) which can be used as a bath oil refill location for the fork lower tubes 103, as well as a port for equalizing air pressure in the fork lower tubes 103 and for facilitating drainage of the bath oil. The bleeder ports 109 can be covered by bleeder port covers 112a, 112b (collectively “bleeder port covers 112”) shown in FIGS. 1, 3, and 5. Generally, the bleeder ports 109 can be positioned at an upper end of the respective fork lower tubes 103a, 103b above a maximum bath oil fill line. To this end, the bleeder ports 109 can allow air to enter or exit the fork lower tubes 103 including, but not limited to, during a fork oil changing process. Moreover, the bleeder ports 109 can provide a fluid pathway that enables bath oil to be poured that causes bath oil to flow into an inner reservoir (not shown) of one or both of the fork lower tubes 103.

The bleeder ports 109 can include openings that can accommodate removable or otherwise adjustable bleeder valves 115a, 115b (collectively “bleeder valves 115”). When the bleeder valves 115 are removed or adjusted, the bleeder ports 109 allow for the refilling of bath oil into the fork lower tubes 103, as will be described. In some embodiments, the bleeder ports 109, acting as refill ports, are positioned above a maximum bath oil fill level of the bath oil when the fork assembly incorporating the fork lower 100 is in an upright position. This positioning can help prevent oil leakage during normal operation while still allowing for easy access during maintenance.

The bleeder valves 115 can each include a button 118 or like mechanical air equalization mechanism. When pressed or otherwise manipulated by a user, the button 118 can cause the bleeder valves 115 to open and allow air to flow in or out of the fork lower tubes 103, equalizing pressure between the interior and exterior. This can further facilitate the draining or refilling of bath oil by preventing air locks or vacuum effects that could impede fluid flow. While a button 118 is described, this mechanical device is merely one example. Other types of devices can also be employed including, but not limited to, rotatable knobs, sliding switches, push-pull plungers, or lever-operated designs that can be manipulated to open or close the air passage and facilitate pressure equalization.

The bleeder valves 115 can be removably coupled to the bleeder ports 109 through various connection mechanisms. In some embodiments, the bleeder valves 115 can include threaded portions that engage with corresponding threads in the bleeder ports 109, allowing for a twisting connection that provides easy installation and removal when needed. Alternatively, the bleeder valves 115 may utilize a quick-release mechanism, such as a push-pull locking mechanism or like mechanism to facilitate rapid removal and reinsertion.

In some embodiments, the bleeder valves 115 can be secured with a retaining clip or snap-fit arrangement that can be disengaged with a simple tool or by hand. The specific attachment method can be selected based on factors such as ease of use, reliability, and compatibility with the overall fork design. Regardless of the attachment mechanism, the bleeder valves 115 can be designed to form a secure, leak-proof seal when installed, the ability to equalize air pressure, and provide access to the bleeder port allowing bath oil maintenance.

The fork lower 100 can further include a through-axle 121 for securely attaching the fork assembly to a wheel of a vehicle (e.g., a front bicycle wheel). In some embodiments, the through-axle 121 can extend between or through both fork lower tubes 103 and a hub of the wheel, providing a connection that enhances characteristics of the suspension. The through-axle 121 can be integral with the fork lower tubes 103 or can include threaded ends (not shown) that engage with corresponding threaded inserts in the fork lower tubes 103 to form a bolt-on connection.

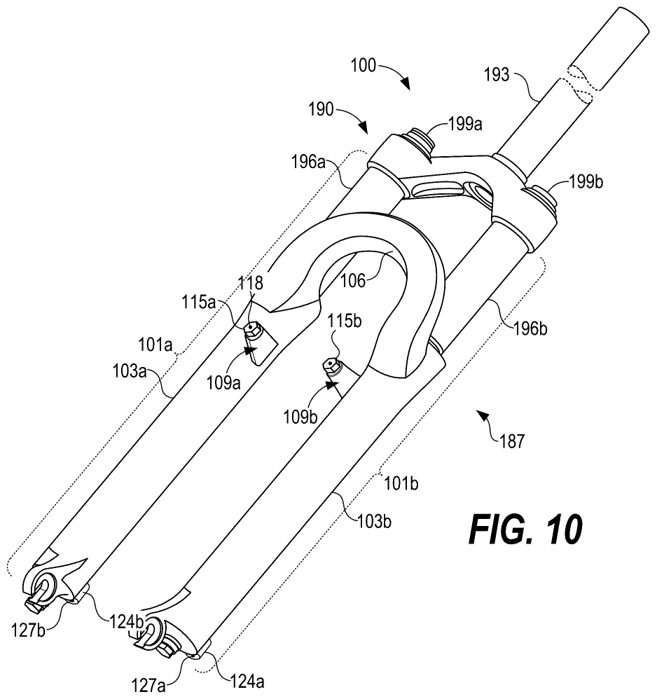

In some embodiments, the fork assembly comprises a first fork leg 101a (FIG. 10) that serves as a damper side and a second fork leg 101b (FIG. 10) that functions as a spring side. The first fork leg 101a and the second fork leg 101b can be collectively referred to as fork legs 101. Each of the fork legs 101 can include a fork lower tube 103 and a fork upper tube, as will be described. To this end, the first fork leg 101a can house various damper components, which can include a piston, shim stacks, and oil chambers to control compression and rebound characteristics of the suspension.

On the other hand, the second fork leg 101b can be configured as a spring side. In some embodiments, a spring on the spring side can be a mechanical spring, a pneumatic spring, or a hydropneumatic spring. In some embodiments, a tube of the second fork leg 101b can contain a sealed air chamber that can be pressurized to provide the main spring force of the suspension. The spring side can include various components, such as pistons, negative spring chambers, and volume spacers to fine-tune the spring rate and progression of the suspension.

This suspension design allows for independent tuning of the damping and spring characteristics of the fork assembly. For example, in one embodiment, users can adjust the air pressure in the air spring side to match their weight and riding style, while separately adjusting the damping settings on the damper side to control the response of the fork assembly to impacts and terrain. The bath oil in each lower tube 103 can be used to lubricate fork stanchions, seals, bushings and other components.

The fork lower tubes 103 can further include drain ports 124a, 124b (collectively “drain ports 124”). In some embodiments, the drain ports 124 are positioned at lower ends of the fork lower tubes 103 below a maximum bath oil fill level to facilitate drainage of bath oil. The drain ports 124 can be integrally formed with the fork lower tubes 103 in some embodiments. For example, the drain ports 124 can be bossed in a metal surface of the fork lower tubes 103, featuring raised sections or protrusions that extend outward and/or downward from the surface of the fork lower tubes 103. This bossed configuration can provide additional structural support, ensure that the drain ports 124 do not impact ride quality, and improve sealing capabilities when the drain ports 124 are closed.

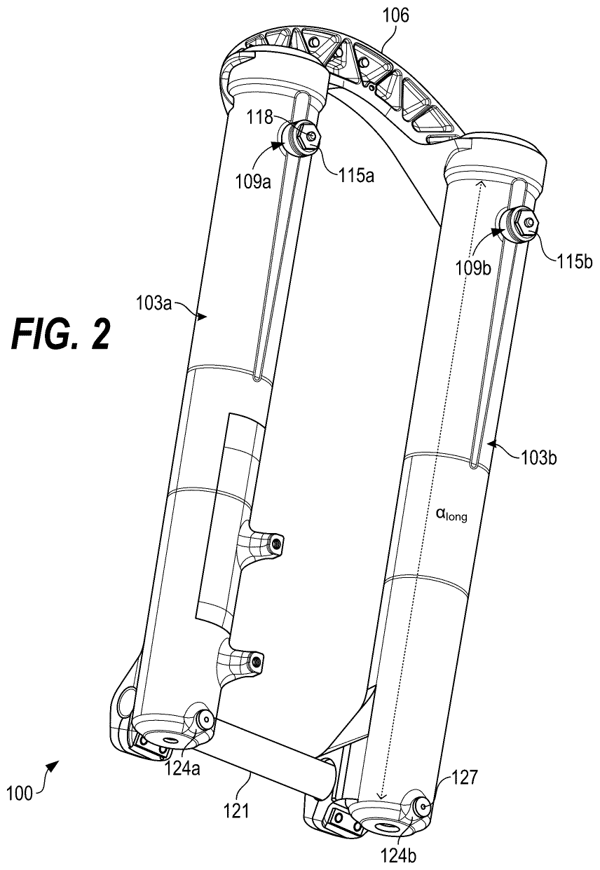

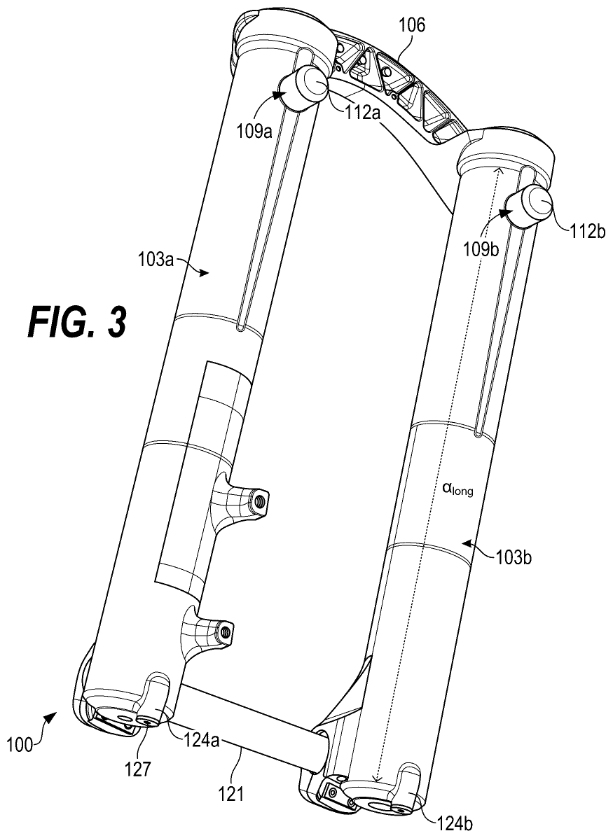

The drain ports 124 can be in a horizontal orientation, shown in FIGS. 1 and 2, or in a vertical orientation, shown in FIGS. 3-5. In a horizontal orientation, the drain ports 124 are substantially perpendicular to a longitudinal axis α_{long} (FIG. 2) of the fork lower tubes 103. The horizontal orientation can be advantageous in certain scenarios, such as when draining oil with the fork assembly in a horizontal position or when space constraints at the bottom of the fork lower tubes 103 necessitate a side-facing port. Substantially horizontally-oriented drain ports 124 can also allow for the integration of specialized drainage fittings or quick-connect systems that operate more effectively in a lateral orientation.

In various embodiments, the drain ports 124 can have a vertical orientation as shown in FIGS. 3-5. To this end, the drain ports 124 can be aligned substantially parallel to a longitudinal axis α_{long} of the fork lower tubes 103. The vertical orientation of the drain ports 124 can allow for efficient drainage when the fork assembly is in an upright position and/or when the fork assembly is installed on a vehicle and the vehicle is in its operating position, utilizing gravity to assist in the oil removal process. The generally vertical orientation can also facilitate the insertion of drainage tools or attachments.

Whether in a vertical, horizontal, or in-between orientation, each drain port 124 can include a drain port opening 127. The size and shape of the drain ports 124 can be tailored to specific requirements of the fork lower 100. For instance, the drain ports 124 can feature tapered or chamfered edges to guide tools or fittings during insertion and removal. The internal diameter of the drain port openings 127 can be designed to accommodate standard drainage equipment while maintaining the structural integrity of the fork lower tubes 103. In some cases, the drain ports 124 can incorporate internal threads or other attachment mechanisms to secure drain plugs or covers and/or valves (not shown) when not in use for maintenance.

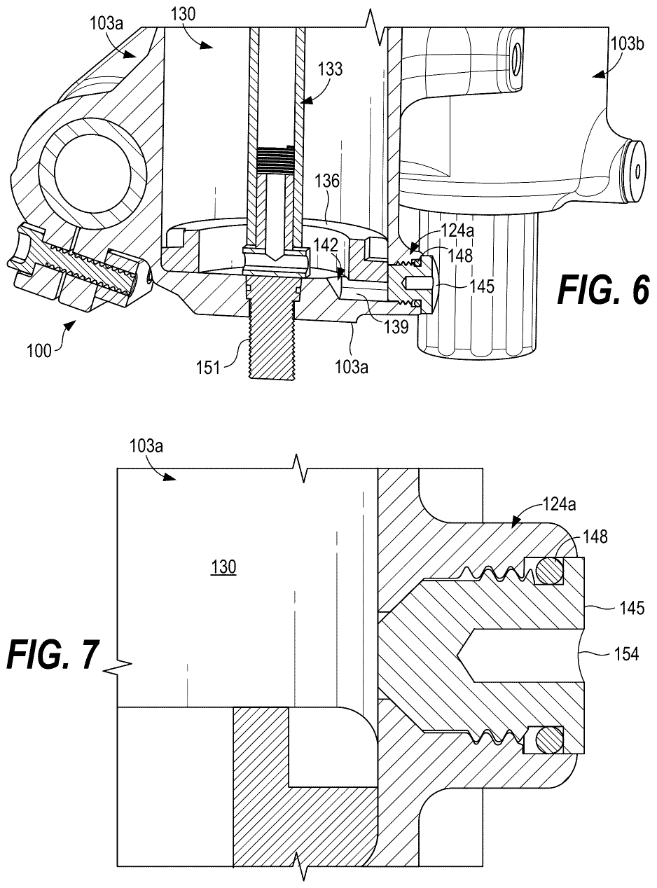

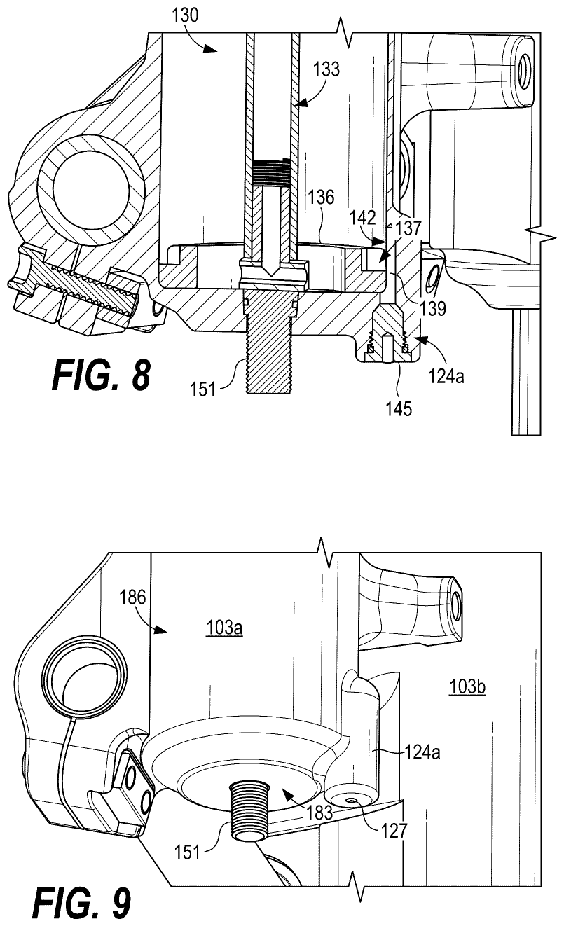

Moving along, FIG. 6 illustrates a partial cross-sectional and a partial perspective view of the fork lower 100 according to various embodiments, with the drain ports 124 in a horizontal orientation. FIG. 7 illustrates a cross-section view of a portion of the fork lower 100 with the drain ports 124 in a horizontal orientation. FIG. 8 illustrates a partial cross-sectional and a partial perspective view of the fork lower 100 according to various embodiments, with the drain ports 124 in a vertical orientation. FIG. 9 illustrates a perspective view of a portion of the fork lower 100 with the drain ports 124 in a vertical orientation.

Referring to FIGS. 6-9, the fork lower tube 103 can include, for example, the first fork lower tube 103a, shown in cross-section in FIGS. 6 and 8, and the second fork lower tube 103b, shown in perspective in FIGS. 6 and 8. Referring generally to the first fork lower tube 103a, the fork lower tube 103 can include an inner reservoir 130 that houses various suspension components. A central shaft assembly 133 can operate in conjunction with a piston (not shown), and can extend through the inner reservoir 130 to guide telescopic motion of the fork assembly, as can be appreciated. Bath oil can be stored in the inner reservoir 130, which is omitted for explanatory purposes. A refill port (e.g., the bleeder port 109) and a drain port 124 can be provided on one or both of the fork lower tubes 103.

A bottom-out bumper 136 can be positioned at the bottom of the inner reservoir 130 (e.g., along a bottom surface). It is understood that, as bath oil is introduced through a refill port, the bath oil will flow down to rest on or around the central shaft assembly 133 and/or the bottom-out bumper 136. Thus, the refill port is fluidly coupled to the inner reservoir 130. An entirety of the inner reservoir 130 shown in FIG. 6, for example, can be filled with bath oil. In other words, a maximum bath oil level can be above the portion of the inner reservoir 130 shown in FIG. 6.

Referring again to FIGS. 6-8 collectively, the bottom-out bumper 136 can have an annular shape conforming to an inner interior surface of the fork lower tubes 103. A channel 137, shown in FIG. 8, can be notched out or otherwise formed on an upper surface of the bottom-out bumper 136 to facilitate movement of the bath oil (e.g., splashing that coats inner components of the fork lower tube 103) as well as drainage of the bath oil in some implementations. The channel 137 can be annular and can extend along an outer diameter of the bottom-out bumper 136. In some embodiments, the channel 137 can extend along an inner diameter of the bottom-out bumper 136. In some embodiments, there may be more than one channel 137 formed in the bottom out bumper.

In some embodiments, at least one channel 137 may be a radially extending channel. In some embodiments, at least one channel 137 may extend at an angle to an upper surface plane of the bottom out bumper. In some embodiments, at least one channel 137 may be at least partially formed in a bottom surface of the bottom-out bumper. The bottom-out bumper 136 can cushion impact when a piston or other suspension component reaches full compression, preventing metal-on-metal contact between various parts of the suspension. The bottom-out bumper 136 can thus be formed of a resilient compressible material, such as rubber or polyurethane, to effectively absorb energy during bottom-out events.

While various embodiments described herein relate to the bottom-out bumper 136 being situated on a bottom surface of the inner reservoir 130, and conforming to the inner diameter of the fork lower tube 103, the disclosure is not so limited. In some embodiments, the bottom-out bumper 136 can be coupled to a fork upper tube (not shown) and can travel with a translation or other movement of the fork upper tube relative to the fork lower tube 103. In some embodiments, the bottom-out bumper 136 can be coupled to the central shaft assembly 133, and can travel with a translation or other movement of the central shaft assembly 133 relative to the fork lower tube 103

The fork lower tube 103 includes the drain port 124 positioned at its lower end in a vertical orientation, horizontal orientation, or an in-between orientation (e.g., at an angle between parallel to the longitudinal axis along and perpendicular to the longitudinal axis α_{long}). The drain port 124 includes a drainage channel 139 that fluidly couples the inner reservoir 130 and the drain port opening 127. For instance, a drainage aperture 142 can be positioned in a bottom surface of the inner reservoir 130 (e.g., on a bottom surface of the interior of the fork lower tube 103a) that directs bath oil from the inner reservoir 130 through the drainage channel 139. Thus, the drain port 124 can be configured to allow drainage of bath oil from the inner reservoir 130 to the exterior. In other words, the drain port 124 provides a fluid pathway between the inner reservoir 130 and the exterior. The drainage channel 139 can include an elongated canal having a diameter sufficient to allow efficient flow of bath oil.

In some embodiments, the drain port 124 can be located in the lowest portion of the fork lower tube, when fork is installed on a vehicle and when the vehicle is in its operating position, which can facilitate complete drainage of the bath oil and ensure the drain port 124 (which, in some embodiments, projects from an outer surface of the fork lower tube 103a) does not interfere with ride quality. The drainage channel 139 can communicate with an opening in a lower surface or bottom surface of the inner reservoir of the fork lower tube 103a. In some embodiments, the opening in the bottom surface of the inner reservoir of the fork lower tube 103a can be located at least partially within an inner diameter of the bottom-out bumper 136, for example.

In some embodiments, the drain port 124 can include a threaded interface that engages with a corresponding threaded portion of a drain plug 145. This threaded engagement can allow for secure closure of the drain port 124 via the drain plug 145 during normal operation while enabling easy removal for maintenance procedures. In some embodiments, the threads can be designed with a specific pitch and count to optimize sealing performance and ease of use. While threaded connections between the drain plug 145 and the drain port 124 are described, it is understood that other types of connections can be employed including, but not limited to, snap connections, friction connections, and so on.

In some embodiments, the drain port 124 and the fork lower tubes 103 can be constructed from aluminum or similar lightweight materials. Aluminum can provide strength, durability, and weight savings, which can be beneficial for overall performance of the fork assembly. The drain plug 145 can also be fabricated from aluminum or like material, allowing for compatibility with the drain port 124 and potentially enabling a metal-to-metal seal when properly installed. In some cases, the use of similar materials for the drain port 124 and drain plug 145 can help prevent issues related to galvanic corrosion. In some embodiments, surface treatments or coatings can be applied to one or more of the fork lower tubes 103 and the drain plug 145 to enhance wear resistance of the components.

The drain plug 145 can be dimensioned to substantially correspond to the drain port 124. In various embodiments, the drain plug 145 and the drain port 124 can include complementary tapered surfaces. In embodiments in which the drain port 124 and the drain plug 145 are both formed of metal, the tapered surfaces can form a metal-on-metal seal when the drain plug 145 is fully tightened into the drain port 124. A seal 148 formed of a silicone or compressible material can assist in the metal-on-metal seal. The seal 148 can include an O-ring, for example, although other types of seals 148 can be employed. The metal-on-metal seal can provide a robust, leak-proof closure that can withstand substantial pressures and vibrations experienced during riding.

The drain plug 145 can include various tool interface configurations to facilitate installation and removal during maintenance procedures. In some embodiments, the drain plug 145 can include a flat-head slot 154, allowing for engagement with a standard flat-head screwdriver. Alternatively, the drain plug 145 can include a Phillips-head recess, accommodating a Phillips screwdriver for manipulation. In other implementations, the drain plug 145 can be designed with a hexagonal socket, enabling the use of an Allen wrench or hex key for tightening and loosening. The specific tool interface chosen for the drain plug 145 can be based on factors such as ease of use, resistance to stripping, and compatibility with tools commonly available to users.

The fork lower 100 can include a base stud 151 positioned at the lower end of the fork lower tube 103, as can be appreciated. The base stud 151 can be integrally formed with the fork lower tube 103, while in other implementations it may be a separate component securely fastened to the fork lower tube 103. The base stud 151 can include a threaded portion that engages with a threaded foot nut (not shown) to secure inner components of the fork lower 100 thereto.

The positioning and design of the drain port 124 can allow for bath oil to be drained without requiring disassembly of the fork assembly. This configuration can simplify maintenance procedures, facilitating servicing of the suspension system. The integration of the drain port 124 into the structure of the fork lower tube 103 can be achieved while maintaining the overall structural integrity and performance characteristics of the suspension system.

As shown in FIGS. 8 and 9, the drain port 124 and the bath oil drainage channel 139 thereof can be oriented generally vertically and parallelly to the longitudinal axis α_{long} of the fork lower tube 103. In some embodiments, the drain port 124 has a body projecting and extending from an outer surface of the fork lower tube 103 that is parallel to the longitudinal axis α_{long}. This vertical orientation can facilitate efficient drainage of the bath oil when the fork assembly is in an upright position and/or when the fork is installed on a vehicle and the vehicle is in its operating position, utilizing gravity to assist in the oil removal process and without having to invert the fork assembly.

As shown in FIG. 8, the bath oil drainage channel 139 may extend from a position below a bottom surface of the inner reservoir 130 to a position above the bottom-out bumper 136. The drainage aperture 142 is formed on a sidewall of the inner reservoir 130 and can be drilled, molded, or otherwise formed therein. The channel 137 of the bottom-out bumper 136 can further orient bath oil along the walls of the inner reservoir 130, directing bath oil to the drainage aperture 142. This configuration can allow for more complete drainage of the bath oil, as it provides a pathway for oil to flow from the lowest point of the inner reservoir 130 to the exterior of the fork lower tube. The vertical orientation and extended length of the drainage channel 139 can also help prevent air locks or vacuum effects that could impede fluid flow during the draining process.

Referring to FIG. 9, the drain port 124a extends generally vertically and parallelly the longitudinal axis α_{long} of the fork lower tubes 103. The drain port 124a is offset from and extends below a bottom surface 183 of an outer tube body 186. The base stud 151 extends below the bottom surface 183 and parallel to the drain port 124a.

Referring next to FIG. 10, FIG. 10 illustrates a perspective view of a fork assembly 187 according to various embodiments of the present disclosure. The fork assembly 187 includes the fork lower 100, a fork upper 190, and a fork steerer tube 193, as can be appreciated. These components work together to provide a suspension system for a vehicle, offering improved ride quality and control over various terrains. The fork upper includes fork upper tubes 196a, 196b (collectively “fork upper tubes 196”) that insert into the fork lower tubes 103a, 103b, respectively, to form a telescopic connection therebetween.

The fork assembly 187 can include a damper 199a and a spring 199b (collectively “suspension components 199”) that can be manipulated by an operator to affect vehicle ride quality. In some aspects, these suspension components 199 can be integrated into the fork upper 190, the fork lower 100, or both, allowing for adjustable compression and rebound characteristics of the suspension system. The suspension components 199 can utilize various mechanisms, such as hydraulic or air-based systems, to control the rate at which the fork assembly 187 compresses and extends during riding.

In some embodiments, the suspension components 199 include external adjustment knobs that allow riders to fine-tune the suspension performance based on terrain conditions, riding style, or personal preferences. The ability to adjust these suspension components 199 can enable riders to optimize their suspension for different scenarios, such as increasing damping for smoother trails or reducing it for rougher terrain.

The fork lower 100, as described in previous figures, includes the first fork lower tube 103a and the second fork lower tube 103b. These lower tubes house the inner reservoirs containing bath oil and various suspension components. The drain ports 124 and bleeder ports 109 are integrated into the fork lower 100, allowing for efficient maintenance and servicing of the suspension system without requiring complete disassembly of the fork assembly 187.

The fork upper 190 telescopically couples with the fork lower 100, with fork upper tubes sliding into the fork lower tubes 103a and 103b. This telescopic arrangement allows for compression and extension of the suspension, absorbing shocks and vibrations encountered during riding. The arch 106 connects the two sides of the fork lower 100, providing lateral stiffness and ensuring proper alignment of the fork legs. The fork steerer tube 196 extends upward from the crown of the fork upper 190 and can be used to attach the fork assembly 187 to a head tube of a vehicle, such as a head tube of a bicycle or motorbike. This allows for steering input from the handlebars to be transmitted to the front wheel, while the suspension components work to maintain traction and comfort.

The embodiment of FIG. 10 shows the drain ports 124a, 124b in a generally vertical orientation, but as previously described, the drain ports 124a, 124b can be in a generally horizontal orientation or an in-between vertical and horizontal orientation. The fork assembly 187 may allow for changing the bath oil while still attached to the vehicle and without disassembly. In some embodiments, the bath oil changing process may involve the following, which may be performed in various orders.

First, the bleeder valves 115 may be removed from the bleeder ports 109 located at the upper end of the fork lower tubes 103. Next, using a suitable tool, such as a flat-head screwdriver, Phillips screwdriver, or Allen wrench, the drain plugs 145 can be removed from the drain ports 124. This action may create an opening for the bath oil to drain from the inner reservoirs 130 to the exterior of the fork assembly 187.

With the drain plugs 145 removed, the bath oil may flow out of the fork lower tubes 103 through the drainage channels 139 and drain ports 124 until all bath oil has been removed. The vertical orientation of the drain ports 124 can facilitate efficient drainage when the bicycle is in an upright position.

Once the old bath oil has been drained, the drain plugs 145 can be reinserted into the drain ports 124 and securely tightened to ensure a proper seal. New bath oil can then be added to the fork lower tubes 103 via the bleeder ports 109. The positioning of the bleeder ports 109 at the upper end of the fork lower tubes 103 may allow for easy pouring of the new oil. After refilling with new bath oil, the bleeder valves 115 may be reinserted into the bleeder ports 109 and secured in place. The bleeder valves 115 can then be adjusted, if necessary, to equalize air pressure, as can be appreciated.

In some embodiments, depending on the design of the refill port valves, refill port covers and/or the drain plugs, the refill port valves, refill port covers and/or the drain plugs may be partially removed or otherwise adjusted or manipulated to provide access to the refill port and the drain port thereby allowing refilling and draining of the bath oil.

This process may allow for efficient maintenance of the fork assembly 187 without the need for removal from the vehicle or complete disassembly of the fork. The integrated drain ports 124 and refill ports 109 can simplify the oil change procedure, potentially encouraging more frequent maintenance to maintain optimal suspension performance. The fork assembly 187 can thus be a part of a vehicle, such as a motorcycle, a bicycle, or other vehicle. The motorcycle, bicycle, or like vehicle can include a frame, a front wheel, and a rear wheel. The fork assembly 187 can be coupled to the frame and can support the front wheel.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A vehicle, comprising:
a frame;
a front wheel;
a rear wheel; and
a fork assembly coupled to the frame and supporting the front wheel, the fork assembly comprising:
a fork upper tube;
a fork lower tube telescopically coupled to the fork upper tube, the fork lower tube being configured to contain bath oil;
a drain port positioned at a lower end of the fork lower tube, the drain port configured to allow drainage of the bath oil; and
a refill port positioned at an upper end of the fork lower tube.

2. The vehicle of claim 1, wherein the drain port is positioned at a lowest portion of the fork lower tube when the fork assembly is installed on a vehicle and the vehicle is in its operating position.

3. The vehicle of claim 2, wherein the vehicle is a motorcycle or a bicycle.

4. A fork assembly, comprising:
a fork lower tube configured to telescopically couple to a fork upper tube, the fork lower tube comprising an inner reservoir;
a bath oil drainage channel;
a drain port positioned at a lower end of the fork lower tube, the drain port being fluidly coupled to the bath oil drainage channel and configured to permit drainage of bath oil from the inner reservoir to an exterior of the fork lower tube; and
a refill port positioned at an upper end of the fork lower tube, wherein the refill port is configured to allow refilling of the bath oil.

5. The fork assembly according to claim 4, wherein the bath oil drainage channel is oriented in a direction extending substantially parallel to a longitudinal axis of the fork lower tube.

6. The fork assembly according to claim 4, wherein the bath oil drainage channel is oriented in a direction transverse to the longitudinal axis of the fork lower tube.

7. The fork assembly according to claim 4, further comprising a bottom out bumper.

8. The fork assembly according to claim 7, wherein the bath oil drainage channel extends below a bottom surface of the inner reservoir.

9. The fork assembly according to claim 4, wherein the bath oil drainage channel is at least partially formed in a side wall of the lower fork tube.

10. The fork assembly according to claim 4, wherein the bath oil drainage channel is at least partially formed in a bottom wall of the lower fork tube.

11. The fork assembly according to claim 4, wherein the drain port is positioned at a lowest portion of the fork lower tube.

12. The fork assembly of claim 4, further comprising a drain sealing device coupled to the drain port and configured to seal and unseal the drain port.

13. The fork assembly of claim 4, wherein the refill port is a bleeder port, and the fork assembly further comprises a bleeder valve coupled to the bleeder port.

14. The fork assembly of claim 13, wherein the bleeder port is configured to equalize pressure between an interior of the fork lower tube and ambient pressure when the port is open.

15. The fork assembly of claim 4, wherein the drain port is located at a rear surface of the fork lower tube.

16. The fork assembly of claim 4, wherein the refill port is positioned above a maximum fill level of the bath oil.

17. The fork assembly of claim 7, wherein the bottom-out bumper comprises at least one channel configured to facilitate drainage of the bath oil through the drain port.

18. The fork assembly of claim 7, wherein the bath oil drainage channel is configured to drain the bath oil from an outer region and from an inner region surrounding the bottom out bumper.

19. A front suspension, comprising:
an upper tube;
a lower tube telescopically coupled to the upper tube, the lower tube being configured to contain bath oil;
a drain port positioned at a lower end of the lower tube, the drain port configured to allow drainage of the bath oil;
a drain sealing device coupled to the drain port;
a refill port positioned at an upper end of the fork lower tube; and
a refill port sealing device coupled to the refill port, wherein the refill port is configured to allow refilling of the bath oil when the refill port is open.

20. The front suspension of claim 19, wherein the drain port is positioned at a lowest portion of the fork lower tube.
